(19) United States
(12) Patent Application Publication
(10) Pub. No.: US 2009/0199563 A1
(43) Pub. Date: Aug. 13, 2009

(54) Scalable pyrospin combustor

(75) Inventor: Daih-Yeou Chen, San Diego, CA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Hamilton Sundstrand Corporation, Rockford, IL (US)

(21) Appl. No.: 12/069,107

(22) Filed: Feb. 7, 2008

(51) Int. Cl. F23R 3/20; F02C 7/22; F02C 7/12

(52) U.S. Cl. 60/740; 60/754

(57) ABSTRACT

An axial-flow pyrospin combustor comprises inner and outer combustor liners and a plurality of pyrospin effusion holes. The inner liner is coaxially mounted inside the outer liner, about a central combustor axis. The pyrospin effusion holes are formed in at least one of the outer combustor liner and the inner combustor liner. Each of the pyrospin effusion holes has a down angle and a back angle, which control a global swirl flow about the central axis, and promote film cooling without detachment.

### BACKGROUND

This invention relates to gas turbine engine combustors, and particularly to annular combustors scalable to small-scale gas turbine engine applications. More specifically, the invention is directed to a scalable, annular combustor with positive combustion control for more efficient combustion.

Fuel efficiency is one of the many advantages of gas turbine engine technology. This is particularly true in larger-scale applications such as industrial gas turbine engines for power generators, and turbofan engines for military and commercial aircraft. It has traditionally been difficult, however, to translate this advantage to smaller-scale applications such as portable power generation and remotely-piloted aircraft, where traditional reciprocating piston engines have scale-related benefits.

Gas turbine engines are typically constructed around a central power core comprising a compressor, a combustor and a turbine. These elements are arranged in flow series, between an upstream air inlet and a downstream exhaust outlet or nozzle. In some engines, the flow series is primarily axial through each engine component, but other engines utilize centrifugal compressors, reverse-flow combustors, or other non-axial flow components.

In operation of a typical gas turbine engine, the compressor compresses inlet air to supercharge the combustor, to power auxiliary pneumatic functions, and to provide cooling air for downstream engine components. The combustor mixes the compressed air with a fuel, and ignites the fuel-air mixture to produce hot combustion gases. The hot combustion gases drive the turbine, which in turn drives the compressor via a common shaft. The engine delivers power in the form of rotational energy from the shaft, reactive thrust from the exhaust, or both.

Engine efficiency is ultimately limited by thermodynamics. Essentially, the Second Law of Thermodynamics requires that the entropy, as defined by the ratio of heat transfer to temperature, not decrease. This limits the thermodynamic efficiency according to the difference between hot combustion gas temperature T₁, at which work is extracted, and exhaust gas temperature T₂, at which waste heat is dispersed to the environment. According to the Second Law, the maximum thermal efficiency (η_{T}) of an engine is:

$${η}_{T} = \frac{{T}_{1} - {T}_{2}}{{T}_{1}} . \qquad [ 1 ]$$

In real engines, work is extracted over a range of temperatures T₁ and combustion products are exhausted over a range of temperatures T₂. In addition, EQ. 1 describes the efficiency of the combustion process (e.g., in the turbine section), and does not include energy consumed by other parts of the engine (e.g., in the compressor). Thus EQ. 1 is an upper limit on actual (net) efficiency. Because exhaust temperature T₂ is limited by the compression ratio, EQ. 1 shows that this upper limit ultimately depends upon combustion temperature T₁.

One advantage of the gas turbine engine is that it can burn fuel at higher temperatures than traditional reciprocating piston designs. The maximum combustion temperature is limited, however, by thermal properties of the engine components, which can melt if they get too hot. Gas turbine engines thus require specialized materials and active cooling techniques, particularly in high-pressure, high-temperature regions near the combustor.

Efficiency also benefits from more uniform combustion. Specifically, fuel and compressed air are often incompletely mixed in the combustor, producing regions with a fuel-air ratio that is either too rich or too lean. This results in lower combustion temperatures or incomplete combustion, with less efficient engine operation and increased emissions. More uniform mixing results in more uniform combustion, increasing engine efficiency and reducing emissions. More uniform combustion also reduces “hot spots” where the combustion temperature exceeds design goals, increasing engine life and reducing the overall cooling load.

There is thus a need for combustor designs with better control of the combustion process. Specifically, there is a need for combustors that produce a more uniform fuel-air mixture and a more uniform combustion temperature, in order to improve engine efficiency while reducing emissions and lowering the cooling load. This need is particularly felt, moreover, in small-scale gas turbine engine applications, where the prior art has been unable to achieve the same advantages exhibited by larger-scale turbine-based engine designs.

### SUMMARY

This invention concerns an annular pyrospin combustor. The combustor comprises inner and outer combustor liners, and is configured for axial fuel injection. The liners are coaxially mounted about a central axis, with the outer liner mounted outside the inner liner.

Pyrospin effusion holes are formed in at least one of the outer combustor liner and the inner combustor liner. Each pyrospin effusion hole has a down angle and a back angle, which control a swirl flow field about the central axis and promote film cooling without detachment. This provides uniform and efficient combustion, with a reduced cooling load. These advantages are scalable to a range of gas turbine engine applications, including miniature propulsion engines and other small-scale applications.

### BRIEF DESCRIPTION OF THE DRAWINGS

FIG. 1 is a perspective view showing one embodiment of a scalable annular pyrospin combustor.

FIG. 2 is a cross-sectional schematic showing one embodiment of an axial-flow gas turbine engine core with the scalable pyrospin combustor of FIG. 1.

FIG. 3 is a cross-sectional side view of the pyrospin combustor in FIG. 1, showing swirling combustion gases with a helical flow path.

FIG. 4 is a schematic diagram of a pyrospin effusion hole, illustrating down angle and back angle geometry.

### DETAILED DESCRIPTION

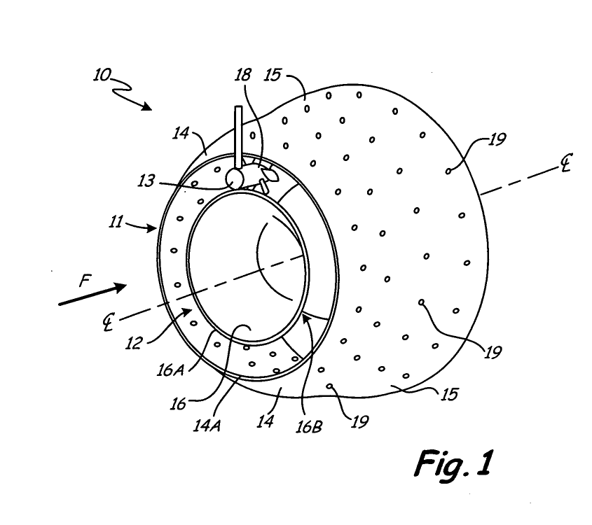

FIG. 1 is a perspective view showing one embodiment of scalable annular pyrospin combustor 10. Combustor 10 comprises outer combustor liner 11 and inner combustor liner 12, and is configured for axial fuel injection with axial fuel injector 13.

Outer combustor liner 11 is an outer diameter or OD liner comprising outer dome (or outer dome section) 14 and outer wall (or outer wall section) 15. Outer wall 15 is located in an axially downstream direction with respect to outer dome 14, as indicated by downstream axial combustion flow arrow F. Downstream direction F lies generally along axial centerline (central axis) C_{L}, and indicates the axial component of combustion gas flow through combustor 10.

Working fluid flows into combustor 10 within OD leading edge 14A of outer dome 14. The radius of outer dome 14 (as measured from centerline C_{L}) increases downstream of leading edge 14A, until outer dome 14 transitions to outer wall 15. The radius of outer wall 15 increases more slowly in the downstream direction than it does in dome region 14.

Inner combustor liner 12 is an inner diameter or ID liner, comprising inner dome (or inner dome section) 16 and inner wall (or inner wall section) 17. Inner dome 16 has a generally decreasing radius downstream of ID leading edge 16A, then transitions through waist region 16B to inner wall 17 where the radius increases again, away from axis C_{L} and toward outer wall 15.

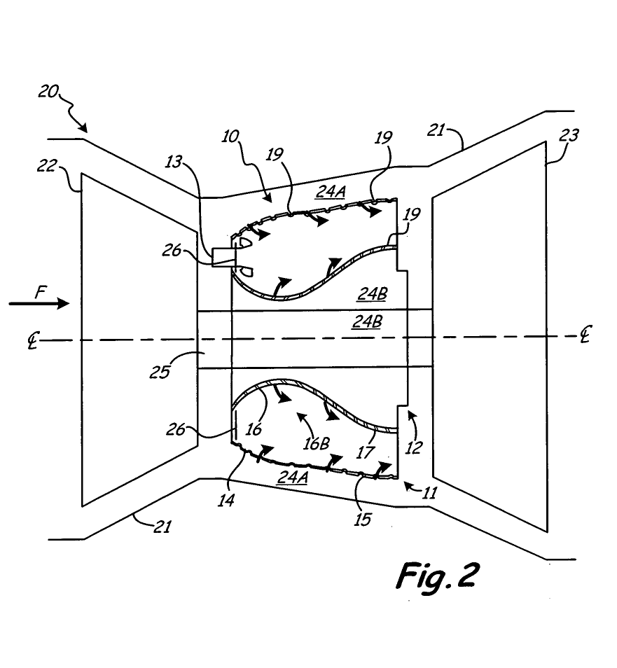

As shown in both FIG. 1 and in FIG. 2, below, outer wall 15 and inner wall 14 each comprise surface of rotation with continuously variable radii, as measured with respect to axis C_{L}. In this embodiment, combustor 10 exhibits an upstream dome section between outer dome 14 and inner dome 16, which surrounds the primary combustion zone. The dome section has a maximum cross-sectional area corresponding to waist region 16B of ID liner 12, where the radius of ID liner 12 decreases toward a minimum value with respect to axis C_{L}. This cross-sectional area then decreases along downstream OD wall 15 and downstream ID wall 17, where the radius of ID liner 12 increases, away from axis C_{L} and toward OD liner 11.

The structure of ID liner 12, as shown in FIGS. 1 and 2, contrasts with the structure of OD liner 11. In particular, the radius of OD liner 11 increases monotonically from outer dome section 14 to outer wall section 15, while the radius of ID liner 12 does not. In further embodiments, both OD liner 11 and ID liner 12 exhibit a waist region of minimum radius, or, alternatively, regions of relatively constant radius where the liner extends substantially parallel to axis C_{L}. In further embodiments, the radius of ID liner 12 decreases monotonically from inner dome 16 to inner wall 17, without waist region 16B.

OD liner 11 and ID liner 12 are typically comprised of a metal alloy that exhibits mechanical strength, surface stability and corrosion/oxidation resistance at high temperatures. In typical embodiments, the combustion liners are comprised of a cobalt, nickel, or nickel-iron superalloy. In these embodiments, OD liner 11 and ID liner 12 are variously formed as unitary structures, or formed from a number of individual dome plates, wall plates, or other combustor liner sections, which are welded or mechanically fastened together to form liners with distinct inner and outer domes section 14 and 16, respectively. In alternate embodiments, OD liner 11 and ID liner 12 are coupled along OD leading edge 14A and ID leading edge 16A to form a unitary dome structure.

Typically, OD liner 11 and ID liner 12 are coated with one or more protective coatings including, but not limited to, bond coats, thermal barrier coatings, carbon deposit inhibiting coatings, and oxidation protective coatings. These protective coatings are variously comprised of aluminides, NiCrAlY (nickel-chromium-aluminum-yttrium) alloys, ceramics, and other protective coating materials. Generally, the protective coatings are applied to interior (hot) surfaces of the combustor liners, in order to protect the liners from degradation due to the hot combustion gases inside combustor 10. Alternatively, protective coatings are applied to any combination of interior (hot) and exterior (cold) surfaces of ID liner 12 and/or OD liner 11, or, alternatively, to neither OD liner 11 nor ID liner 12.

Axial fuel injector 13 comprises a fuel injector tip, air splitter, air blast atomizer or other fuel injector components (not shown), configured to inject fuel substantially axially into combustor 10. In the particular embodiment of FIG. 1, fuel injector 13 injects fuel into combustor 10 between OD leading edge 14A of outer combustor liner 11, and ID leading edge 16A of inner combustor liner 12. In embodiments where OD liner 11 and ID liner 12 are coupled to form a single dome or dome plate, fuel injector 13 is typically mounted to a fuel injector port or air/fuel aperture. In alternate embodiments fuel injector 13 is mounted to a separate dome plate, which is distinct from the OD and ID liners, as shown in FIG. 2.

While FIG. 1 illustrates combustor 10 with a single axial fuel injector 13, combustor 10 also encompasses multiple fuel injector embodiments. In these embodiments, a plurality of fuel injectors 13 are arranged circumferentially about combustor 10 proximate outer dome 14 and inner dome 16, in order to inject fuel axially into a number of different locations within combustor 10.

Axial fuel injector 13 typically includes swirler 18. Swirler 18 comprises flow surfaces such as swirler vanes, swirler flanges, swirler cones, deflector flare assemblies or Venturi channels, which are configured to mix fuel from fuel injector 13 with compressed air inside combustor 10.

In some embodiments, one swirler 18 is mounted to each fuel injector 13, as shown in FIG. 1. In alternate embodiments, one or more swirlers 18 are mounted to ID liner 12 or OD liner 11. Note, however, that the function of swirler 18 is distinguished from the function of pyrospin effusion holes 19, below. Specifically, swirler 18 promotes local swirl flow in a primary fuel-air combustion zone proximate fuel injector 13 and dome portions 14, 16. Pyrospin effusion holes 19, in contrast, are designed to provide positive flow and combustion control not only the primary combustion zone (that is the dome section of the combustor, between dome section 14 of OD liner 11 and dome section 16 of ID liner 12), but also in downstream portions of combustor 10.

In addition, combustor 10 provides spin or swirl around central axis C_{L}, rather than swirl that is localized to particular regions of the dome or primary combustion zone. Pyrospin effusion holes 19 thus control a global, non-localized swirl flow field oriented about central axis C_{L} of combustor 10, and extending from the primary combustion zone or dome section to downstream regions of combustor 10.

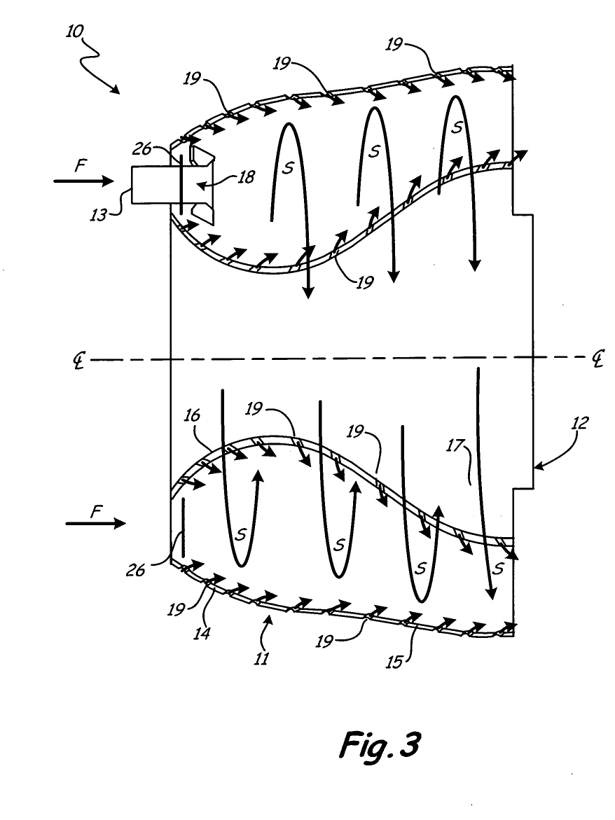

As shown in FIG. 1, pyrospin effusion holes 19 are formed in ID liner 12 along outer dome 14 and outer wall 15. This configuration is, however, merely illustrative. In alternate embodiments, pyrospin effusion holes 19 are formed in any or all of outer dome 14, outer wall 15, inner dome 16, and inner wall 17 (see FIGS. 2 and 3, below).

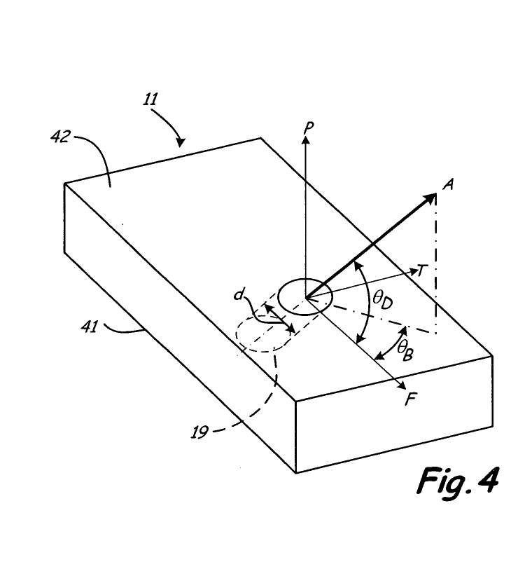

In contrast to previous combustor configurations with traditional cooling hole or cooling strip configurations, pyrospin effusion holes 19 are formed in combustor 10 with combined downstream and back angle geometries (see FIG. 4, below). This allows pyrospin effusion holes 19 to provide positive combustion control by performing a number of functions including, but not limited to, flow field control, fuel-air mixing, oxidation, film cooling, and dilution. In further contrast to the prior art, pyrospin effusion holes 19 are configurable to provide positive combustion control along any of the combustor dome and inner or outer wall sections, including both the primary combustion section and downstream regions as well. This gives annular pyrospin combustor 10 significant advantages over more traditional prior art designs, as described in detail below.

FIG. 2 is a cross-sectional schematic showing one embodiment of axial-flow gas turbine engine core 20 with scalable pyrospin combustor 10. Combustor 10 comprises outer combustor liner 11 and inner combustor liner 12, which are configured for axial fuel injection via fuel injector 13, as described above. Gas turbine engine core 20 comprises engine housing 21 with compressor 22 and turbine 23 arranged in flow series about combustor 10.

Outer combustor liner (OD liner) 11 is mounted coaxially about inner combustor liner 12, to form annular combustor 10 around central axis C_{L}. Combustor 10, in turn, is coaxially mounted within engine housing 21. Typically, there is also an outer combustor annulus or outer plenum (not shown), forming outer plenum region 24 proximate OD liner 11. In some embodiments, an inner combustor annulus or inner plenum (not shown) also forms inner plenum region 24 proximate ID liner 12. In further embodiments, turbine 23 extends axially such that the inner plenum is formed between ID liner 12 and a turbine shroud.

In the particular embodiment of FIG. 2, working fluid flows substantially axially through gas turbine engine core 20 and combustor 10, as shown by downstream direction F. Compressor 22 and turbine 23 are coaxially mounted about centerline C_{L}, with compressor 22 upstream (to the left) of combustor 10, and turbine 23 downstream (to the right). Turbine 23 is coupled to compressor 22 via shaft 25.

With the exception of combustor 10, the elements of gas turbine engine core 20 are merely illustrative. Thus engine core 20 encompasses a broad range of gas turbine engine configurations. In multi-spool embodiments, for example, compressor 22 represents a number of compressor spools, turbine 24 represents a number of turbine spools, and shaft 25 represents a number of coaxially nested spool shafts. Engine core 20 also encompasses ground-based industrial gas turbine engine cores for power generation or other industrial use, turbojet and turbofan engine cores for aviation, auxiliary power unit (APU) engine cores, and small-scale gas turbine engine cores for specialized applications, such as unmanned aircraft or other miniature propulsion engines.

In addition, some embodiments of combustor 10 include upstream dome plate 26, which is distinct from outer dome section 14 and inner dome section 16 of OD liner 11 and ID liner 12, respectively. In these embodiments, upstream dome plate 26 is typically of annular construction, oriented perpendicularly about axial centerline C_{L} at the upstream end of combustor 10. When upstream dome plate 26 is provided, axial fuel injectors 13 and swirlers 18 are typically mounted in fuel injector/oxidizer apertures in the upstream dome plate. In addition, film cooling slots are typically provided between upstream dome plate 26 and leading edge 14A of outer dome section 14, and between dome plate 26 and leading edge 16A of inner dome section 16, in order to cool upstream components in the dome section or primary combustion zone of combustor 10.

Note also that downstream direction F defines the relevant features of combustor 10 in terms of the combustion gas flow, independently of other working fluid flows in other engine components. Thus combustor 10 is applicable to a wide range of gas turbine engine designs. These designs include not only the axial flow configuration of FIG. 2, but also centrifugal and reverse-flow engine configurations in which the flow of combustion gases has an axial component through combustor 10.

Moreover, the overall dimensions of combustor 10 are scalable based upon the specific configuration of engine core 20. In commercial and military aviation applications, for example, combustor 10 typically has a diameter of eighteen inches (18″) or more (D≧45 cm). In auxiliary power unit applications, the diameter is typically between six and eighteen inches (6″≦D≦18″, or 15 cm≦D≦45 cm), and in various small-scale or “miniature” applications, diameter D is typically less than six inches (D≦6″, or D≦15 cm). The length of combustor 10 also typically varies, from five inches (5″) or more (L≧13 cm) for APU and aircraft propulsion applications, to approximately two and one half inches (2.5″) or less (L≦6.4 cm) for small-scale applications. In each of these embodiments the aspect ratio (the ratio of length to diameter, or L/D) also varies, depending upon the particular requirements of the desired application.

In operation of engine core 20, compressor 22 compresses air to supercharge combustor 10. As shown in FIG. 2, the compressed air enters combustor 10 between outer dome 14 and inner dome 16 of OD liner 11 and ID liner 12, respectively. Alternatively, outer dome 14 and inner dome 16 are mechanically coupled, or a separate dome plate is provided, and the compressed air enters combustor 10 via a fuel injector port, air/fuel aperture or similar structure.

Combustor 10 mixes the compressed air from compressor 22 with fuel from fuel injector 13, and the resulting fuel-air mixture is ignited to produce hot combustion gases. The combustion gases exit combustor 10 in the downstream direction to drive turbine 23, which in turn drives compressor 22 via shaft 25. Gas turbine engine core 20 provides mechanical energy in rotational form, via a mechanical coupling (not shown) to shaft 25, or in the form of reactive thrust, via an exhaust nozzle (also not shown) downstream of turbine 23. In some embodiments, gas turbine engine core 20 provides both rotational energy and reactive thrust.

Compressed air from compressor 22 also enters outer plenum region 24, proximate OD liner 11, and, in some embodiments, inner plenum region 24, proximate ID liner 12. Compressed air in the plenum region (or regions) enters combustor 10 via pyrospin effusion holes 19, which are provided in OD liner 11, ID liner 12, or both.

FIG. 3 is a cross-sectional side view of pyrospin combustor 10, showing swirling combustion gas with a helical flow field. Combustor 10 comprises OD liner 11, ID liner 12 and fuel injector 13, as described above, with pyrospin effusion holes 19 provided in at least one of OD liner 11 and ID liner 12.

In contrast to previous combustors utilizing traditional effusion and cooling hole geometries, pyrospin effusion holes 19 have both a down angle (or downstream angle), as measured from the axial (downstream) flow direction F toward perpendicular, and a back angle (or swirl angle), as measured from F toward a tangential flow direction. The tangential flow direction lies along the surface perpendicular to downstream direction F (see FIG. 4), such that pyrospin effusion holes 19 impart a combined tangential and axial swirling flow onto the combustion gas. This generates a global flow field oriented in a helical sense about central axis C_{L}, as shown by swirl flow arrows S.

In the particular embodiment of FIG. 3, the swirl flow field curls about axis C_{L} in a right-hand sense with respect to downstream direction F. Thus the swirl helix has a clockwise orientation when viewed in the downstream flow direction, and pyrospin effusion holes 19 are said to have a clockwise swirl angle. In alternate embodiments, pyrospin effusion holes 19 have a counter-clockwise (or anti-clockwise) swirl angle. In these embodiments, pyrospin effusion holes 19 control a left-handed swirl flow field, and swirl flow arrows S described a left-handed helix about axis C_{L}.

Pyrospin effusion holes 19 provide positive control of a global swirl flow field along combustor 10. This contrasts with prior art combustion liners, in which tangentially-angled holes or other swirl-generating devices promote locally helical swirl flow, but do not control a global swirl flow field that varies smoothly within the combustor and is helical about a central axis with a uniform clockwise or anti-clockwise rotational sense.

Pyrospin effusion holes 19 also perform the function of film cooling holes. Specifically, cooling air from plenum region 22A enters combustor 10 by crossing OD liner 11 from the exterior surface (the cold or plenum side) to the interior surface (the hot or combustion side). The cooling air exits pyrospin effusion holes 19 to form a cooling film along the interior surface of combustor 10, protecting OD liner 11 from degradation due to the hot combustion gases inside combustor 10.

Because pyrospin effusion holes 19 have both a back angle (or swirl angle) and a down angle (or downstream angle), they encourage a smooth transition from flow within holes 19 to laminar flow along the inner (hot) surface of OD 11, with less detachment than prior art designs. This distinguishes from perpendicular cooling or effusion holes, and from other cooling or effusion configurations that do not have both a back angle and a down angle.

ID liner 12 is similarly configurable with pyrospin effusion holes 19. In this case, the holes provide cooling air from inner plenum region 24, between ID liner 12 and shaft 25. In embodiments where pyrospin effusion holes 19 are provided in both OD liner 11 and ID liner 12, the pyrospin effusion hole geometries are coordinated to promote a global swirling flow that varies smoothly along the hot (interior) surfaces of both liners, as well as the interior region of combustor 10 between OD liner 11 and ID liner 12, and from the primary combustion zone or dome section to the downstream walls.

Pyrospin effusion holes 19 also increase the uniformity of fuel-air mixing by providing additional oxidant, further promoting faster combustion with a more uniform temperature distribution. This reduces hot spots and cold spots, in which the combustion temperature falls out of a desired range, and allows combustor 10 to provide efficient combustion and decreased emissions with a lower cooling load.

In some embodiments, pyrospin effusion holes 19 also dilute the fuel-air mixture. Dilution controls the pressure and temperature in a dilution zone upstream of the turbine section, allowing the combustion gas characteristics to be altered before energy is extracted.

In contrast to more complex structures such as cooling strips or air baffling structures, pyrospin effusion holes 19 are provided at any location along either OD liner 11 or ID liner 12, or both. This makes combustor 10 configurable to provide positive combustion control not only in upstream sections proximate the dome, but also in downstream sections along the combustor walls, where previous designs do not have positive control of the flow field.

The down angles, back angles, and cross-sectional areas of each pyrospin effusion hole 19 are determined as a function of the plenum overpressure, as measured across the combustor liner, and the flow resistance, which is a function of cross-sectional area and liner thickness. This allows holes 10 to provide a regulated flow that yields a desired combination of swirl flow control, film cooling, oxidation flow and dilution flow.

In particular, the geometry of pyrospin effusion holes 19 converts a plenum overpressure on the exterior (cold surface) of the combustor liner into a specific vector flow velocity on the interior (hot surface), as determined by the down and back angles. This contrasts with perpendicular or near-perpendicular holes in the prior art, which generate jet flows that detach from the inner surface. This also contrasts with other prior art structures that do not convert an overpressure into a vector fluid flow, either because the cross-sectional area of the hole is too large with respect to the liner diameter, or because the structure comprises baffles or other turbulence-inducing features.

The key to efficient combustion is control of the flow field. This includes the rotational rate of swirl flow about the central axis, oxidation, fuel-air mixture uniformity, film cooling, and dilution. Pyrospin effusion holes 19 are configurable to provide positive control of these quantities all along the dome and walls of combustor 10, providing more uniform, more efficient, and more complete combustion, with lower emissions and a reduced cooling load.

The flow through pyrospin effusion holes 19 is regulated by adjusting the density of pyrospin effusion holes 19 as a function of location, in order to optimize positive combustion control along combustor 10. Alternatively, the back angle, down angle, and cross-sectional area are varied among individual holes as a function of location. The geometry and density of pyrospin effusion holes 19 thus provides a flexible control mechanism that is adaptable to particular combustor geometries and scalable to a range of gas turbine engine applications. These include not only traditional large-scale applications such as jet engines and industrial gas turbines for power generation, but a range of smaller-scale applications as well, including miniature propulsion engines.

FIG. 4 is a schematic diagram of pyrospin effusion hole 19, illustrating down angle and back angle geometry. Pyrospin effusion hole 19 traverses OD liner 11 from exterior (cold) surface 41 to interior (hot) surface 42.

In the particular illustration of FIG. 4, pyrospin effusion hole 19 traverses OD liner 11 in a location near the bottom of FIGS. 1 and 2, above, such that exterior (cold) surface 41 is an underside of OD liner 11, and interior (hot) surface 42 is a top side of OD liner 11. This relative description is however arbitrary, and varies with location.

In particular, hole angles are often defined according to the drill angle; that is, according to the surface or side from which the hill is drilled. In some cases, the hole is drilled from hot side 42 to cold side 41, as suggested by FIG. 4, and in other cases the hole is drilled from cold side 41 to hot side 42. In addition, holes are typically provided in both OD liner 11 and the ID liner, as shown above in FIGS. 1-3.

In the particular configuration of FIG. 4, hole axis A extends along the geometrical center of pyrospin effusion hole 19, and is projected out of OD liner 11 in order to show its geometrical relationship with downstream flow direction F, tangential flow direction T and perpendicular P. Downstream (axial) flow direction F lies along surface 42 of the combustor, in a plane parallel to the central axis. Perpendicular P extends orthogonally from surface 42, perpendicular to downstream direction F. Tangential flow direction T is tangential to interior surface 42, and perpendicular to both axial flow direction F and perpendicular direction P. In this particular embodiment, tangential flow direction T is further oriented in a right-handed or clockwise sense, in order to form a right-handed coordinate system with perpendicular P, as downstream direction F rotates back toward tangential flow direction T. In other embodiments, tangential flow direction T has a left-handed or counterclockwise sense, as described above.

Pyrospin effusion holes 19 are typically formed by a drilling technique, including, but not limited to, laser drilling, laser machining, laser percussion drilling, mechanical drilling, mechanical machining, and electron discharge machine (EDM) techniques. Pyrospin effusion hole 19 are further formed either in a substantially planer section of OD liner 11, as illustrated in FIG. 4, or in any combination planar and non-planar sections (or plates) of outer dome 14, outer wall 15, inner dome 16, and inner wall 17, as shown in FIGS. 1 and 2, above.

In the embodiment of FIG. 4, pyrospin effusion hole 19 has a circular cross section with diameter d, producing oval intersections with exterior surface 41 and interior surface 42 of OD liner 11. Diameter d is determined as a function of the plenum overpressure, which is the pressure differential between exterior surface 41, in the plenum region, and interior surface 42, in the interior of the combustor. Specifically, diameter d is determined in order to convert the plenum overpressure to a vector flow, and to regulate a flow rate with desired swirl control, oxidation, fuel-air mixing, film cooling, and dilution functionality.

In other embodiments, pyrospin effusion hole 19 has a variety of cross sections, including circular, oval, rectangular, or other geometrical cross-sections, and irregular cross sections. In these embodiments, the flow rate is regulated as a function of the cross-sectional area of pyrospin effusion hole 19, or by a geometrical parameter characterizing the cross-sectional area, such as a length or a width.

FIG. 4 also illustrates the geometry of down (downstream) angle θ_{D} and back (swirl) angle θ_{B} for pyrospin effusion hole 19. Down angle θ_{D} is measured from downstream direction F (along the surface of the combustor) toward perpendicular P; that is, the down angle is measured in a plane containing the axial flow direction and a perpendicular to the surface. Back angle θ_{S} is measured from downstream direction F toward the direction of tangential flow T; that is, the back angle is measured in a plane tangent to the surface, and represents rotation from the downstream direction back toward the tangential flow direction. Thus the back angle is measured along the surface of the combustor, as the axis rotates away from F and toward T, about perpendicular P.

The cross-sectional area, down angle and back angle typically vary as a function of the location of pyrospin effusion hole 19 and the plenum overpressure, in order to promote uniform fuel-air mixture and combustion with a smoothly-varying swirl flow along the combustor liners, and to provide effective film cooling, swirl velocity, oxidation, and (in some embodiments) dilution flow along the hot (interior) surface of the combustor.

Pyrospin effusion holes 19 are generally circular, with diameter d varying as a function of the plenum overpressure (the pressure differential across the combustor liner), and the thickness of the liner (which affects flow resistance). In typical embodiments, the combustor liner thickness is on the order of twenty-five to fifty mils (thousandths of an inch), or 0.025″-0.050″ (0.64-1.27 mm). In these embodiments, pyrospin effusion holes 19 have diameter d between fifteen and thirty mils (0.015″-0.030″, or 0.38-0.76 mm). In alternate embodiments, particularly for combustor liner thicknesses of up to one hundred mils (0.100°), diameter d is as great as fifty mils (0.050″, or 1.27 mm) or more. Alternatively, diameter d varies among individual holes as a function of position, from a minimum of fifteen mils (0.015″, or 0.38 mm) or less, to a maximum of thirty mils (0.030″, or 0.76 mm) or more. In further alternate embodiments, pyrospin effusion holes 19 have a non-circular cross section, but have an equivalent cross-sectional area corresponding to a circular hole with a diameter falling into one of the above ranges.

In typical embodiments, the down angle is about twenty degrees (20°). In some embodiments, the down angle is between about fifteen degrees (15°), which is a practical lower limit for many drilling techniques, and about thirty degrees (θ_{D}≦30°). The down angle has a theoretical maximum of ninety degrees (90°), where the hole becomes perpendicular along P and does not have a component along downstream direction F, and a practical maximum of about forty-five degrees (45°), in order to promote film cooling without detachment.

In typical embodiments, the back angle is about forty-five degrees (45°) or more. The back angle has a practical minimum of about thirty degrees (30°), in order to control a global swirl flow, and a theoretical maximum of ninety degrees (90°), where the axis is rotated back to tangential direction T and no longer has a downstream component along F. In some embodiments, however, the back and down angles of individual holes vary, and sometimes fall above or below these described ranges.

Although the present invention has been described with reference to preferred embodiments, the terminology used is for the purposes of description, not limitation. Workers skilled in the art will recognize that changes may be made in form and detail without departing from the spirit and scope of the invention.

1. An annular pyrospin combustor configured for axial fuel injection, the combustor comprising:
an outer combustor liner;
an inner combustor liner coaxially mounted within the outer combustor liner, about a central axis of the combustor; and
a plurality of pyrospin effusion holes formed in at least one of the outer combustor liner and the inner combustor liner, wherein each pyrospin effusion hole has a down angle and a back angle to control a global swirl flow about the central axis, and to promote film cooling without detachment.

2. The combustor of claim 1, further comprising an axial fuel injector for injecting fuel axially into a primary combustion zone between the outer combustor liner and the inner combustor liner.

3. The combustor of claim 2, wherein the pyrospin effusion holes control the global swirl pattern in the primary combustion zone and downstream of the primary combustion zone.

4. The combustor of claim 1, wherein the pyrospin effusion holes convert a plenum overpressure on a cold side of the combustor to a vector fluid flow on a hot side of the combustor.

5. The combustor of claim 1, wherein the combustor is scalable to a diameter of less than about eighteen inches (about 45 cm).

6. The combustor of claim 5, wherein the combustor is further scalable to a diameter of about six inches (about 15 cm) or less.

7. The combustor of claim 3, wherein the down angle is between about fifteen degrees and about forty-five degrees.

8. The combustor of claim 6, wherein the back angle is at least about thirty degrees.

9. The combustor of claim 1, wherein the pyrospin effusion holes each have a hole diameter less than about fifty thousandths of an inch (about 1.27 mm).

10. The combustor of claim 8, wherein the pyrospin effusion holes are provided on both the inner liner and the outer liner.

11. The combustor of claim 2, wherein the pyrospin effusion holes are provided in both the primary combustion zone and along combustor walls downstream of the primary combustion zone.

12. The combustor of claim 1, in combination with a gas turbine engine.

13. A scalable axial-flow pyrospin combustor comprising:
a combustor dome;
an outer combustor liner extending from the dome to an outer wall located in a downstream direction from the dome;
an inner combustor liner extending from the dome to an inner wall located in the downstream direction from the dome, and coaxially mounted within the outer combustor liner wall; and
a plurality of pyrospin effusion holes provided on at least one of the combustor dome, the outer wall, and the inner wall;
wherein each of the pyrospin effusion holes has a back angle to control a global swirl flow about the central axis, and a down angle to promote film cooling without detachment.

14. The combustor of claim 13, wherein the combustor is scalable to a diameter of about six inches (about 15 cm) or less.

15. The combustor of claim 13, wherein each of the pyrospin effusion holes has a diameter between about fifteen thousandths of an inch (about 0.38 mm) and about fifty thousands of an inch (about 1.27 mm).

16. The combustor of claim 15, wherein the down angle is at least fifteen degrees (15°).

17. The combustor of claim 15, wherein the back angle is at least thirty degrees (30°).

18. The combustor of claim 13, wherein a density of the pyrospin effusion holes is varied in a downstream direction from the combustor dome, in order to provide positive combustion control downstream of a primary combustion zone in the combustor dome.

19. The combustor of claim 13, in combination with a gas turbine engine.

20. A method of operating a scalable annular combustor for a gas turbine engine, the method comprising:
introducing a compressed air and fuel mixture into a dome section of the combustor in an axial direction; and
introducing compressed air into the combustor via a plurality of pyrospin effusion holes, each having a down angle and a back angle;
wherein the pyrospin effusion holes control a global swirl flow about a central axis of the combustor and promote film cooling without detachment.

21. The method of claim 20, wherein introducing compressed air into the combustor comprises introducing compressed air at a down angle between about fifteen degrees (15°) and about thirty degrees (45°).

22. The method of claim 20, wherein introducing compressed air into the combustor comprises introducing compressed air at a back angle greater than about thirty degrees (30°).

23. The method of claim 20, wherein introducing compressed air into the combustor comprises converting a plenum overpressure into a vector flow via a pyrospin effusion hole with a diameter between fifteen thousandths of an inch (about 0.38 mm) and thirty thousandths of an inch (about 0.76 mm).

24. The method of claim 21, wherein the pyrospin effusion holes control the global swirl flow about the central axis of a combustor with a diameter of about six inches (about 15 cm) or less.
